(19) United States
(12) Patent Application Publication
(10) Pub. No.: US 2025/0059469 A1
(43) Pub. Date: Feb. 20, 2025

(54) NEW CATIONIC POLYMERS, PROCESS FOR PRODUCING THE SAME FROM MONOUREA DIAMINE CONDENSATES AND ETHER DERIVATIVES, AND USES THEREOF

(71) Applicant: SPECIALTY OPERATIONS FRANCE, Lyon (FR)

(72) Inventors: Wojciech Bzducha, Courbevoie (FR); Sujandi Zhou, Singapore (SG); David James Wilson, Coye-la-Forêt (FR)

(73) Assignee: SPECIALTY OPERATIONS FRANCE, Lyon (FR)

(21) Appl. No.: 18/721,091

(22) PCT Filed: Dec. 6, 2022
(86) PCT No.: PCT/EP2022/084534

§ 371 Date: Jun. 17, 2024

(30) Foreign Application Priority Data
Dec. 17, 2021 (EP) 21215390.2

(51) Int. Cl. C11D 3/37; C08G 73/02; C11D 3/00; C11D 3/48

(52) U.S. Cl. CPC C11D 3/3723; C08G 73/024; C11D 3/0021; C11D 3/0036; C11D 3/48; C08G 2230/00

(57) ABSTRACT

The present invention relates to new cationic polymers, a synthesis process for preparing them from monourea diamine condensates and bifunctional ether derivatives, notably dihalogeno ether derivatives, and to the use of said new cationic polymers for surface treatment applications including, but not limited to, home and personal care applications as well as industrial and institutional cleaning applications.

This application claims priority to the application filed on Dec. 17, 2021 in Europe with Nr 21215390.2, the whole content of this application being incorporated herein by reference for all purposes.

The present invention relates to new cationic polymers, a synthesis process for preparing them from monourea diamine condensates and bifunctional ether derivatives, notably dihalogeno ether derivatives, and to the use of said new cationic polymers for surface treatment applications including, but not limited to, home and personal care applications as well as industrial and institutional cleaning applications.

### BACKGROUND

Cationic polymers obtained by reaction between monourea diamine condensates and dichloroalkyl ethers (notably bis-chloroethyl ethers) are known for their antimicrobial properties on one hand from WO11148950 A1, and for their performance for fixing colors and/or inhibiting the running of colors in laundry formulations on the other hand from US 2009/0005286 A1. Unfortunately, even if their performances are recognized in said applications, such highly cationic polymers are now classified as H410, i.e. very toxic to aquatic life with long lasting effects.

There is thus a need to find new chemical solutions with an improved eco-toxicity profile while preserving or even improving the surface treatment performances. The new chemical solution that is expected in this field would in addition present an improved biodegradability profile compared to already known cationic polymers made from monourea diamine condensates and dichloroalkyl ethers.

### BRIEF DESCRIPTION

One aim of the invention is thus to provide a new cationic polymer, that is able to replace existing cationic polymers in all applications they are intended for, notably as hygiene booster agent and dye transfer inhibitor, and that present a good eco-toxicity profile and a better biodegradability compared to existing cationic polymers. The invention further aims at providing a process that allow preparing such new cationic polymers, formulations comprising the same and various uses of said polymers.

To this end, the instant invention provides a new family of polymers, which reveal to provide especially good performances in surface treatment application, notably as hygiene booster agent and dye transfer inhibitor, while being harmless to the environment.

More precisely, according to a first aspect, one subject matter of the instant invention is a new polymer comprising the following repeating unit of formula I:

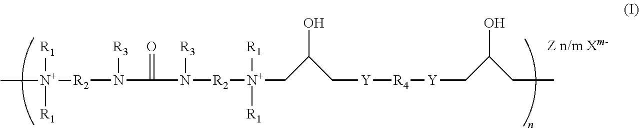

wherein:
R₁ are each independently a hydrogen atom, a C₁ to C₄ alkyl or hydroxyalkyl group, or a C₂ to C₄ alkenyl group;
R₂ are each independently a C₂ to C₁₀ alkylene group;
R₃ are each independently a hydrogen atom, a C₁ to C₄ alkyl or hydroxyalkyl group, or a C₂ to C₄ alkenyl group;
R₄ represents an oxyalkylene group of formula A:

(—CHR₅CH₂)ₐ-(OCH₂CHR₆)_{b}-(OCH₂CHR₇)_{c}-(OCH₂CHR₈)_{d} (A)

wherein
“a” represents 1;
“b” represents an integer of 1 or more;
“c” and “d” represent independently from one another an integer of 0 or more; and
R₅, R₆, R₇ and R& represent independently from one another a hydrogen atom or a C₁ to C₄ alkyl group;
Y represents an oxygen atom, —NR₉- or —N⁺R₁₀R₁₁- wherein:

R₉ represents a hydrogen atom or a radical deriving from any electrophilic compound present in the reaction mixture during the synthesis process of the polymer of the invention and that reacted by alkylation reaction with a secondary amine (Y=—NH—) present on the polymer of the invention during its synthesis; and

R₁₀ and R₁₁ represent radicals deriving from any electrophilic compounds present in the reaction mixture during the synthesis process of the polymer of the invention and that reacted by successive alkylation reactions with a secondary amine (Y=—NH—) and then a tertiary amine (e.g. Y=—NR₁₀-) present on the polymer of the invention during its synthesis;
Z represents a positive integer from 2 to 4;
n represents a positive integer from 1 to 50;
m represents a positive integer from 1 to 3; and
X represents an electrophilic group, preferably selected from halogens or sulfates.

The polymers comprising the repeating unit of formula I present a good eco-toxicity profile and a better biodegradability compared to existing cationic polymers.

The polymers comprising the repeating unit of formula I are highly efficacious macromolecular antimicrobials, which is one first advantage, especially since the polymers comprising the repeating unit of formula I do not lead to production of harmful degradation byproducts being resistant to hydrolysis thanks to stable urea functionality when used for home and personal care (HPC) applications at pH different from neutral and being less detrimental to waterways and food supplies in comparison to triclosan (antimicrobial agent commonly used in HPC applications).

There are many factors that influence antimicrobial activity and selectivity of the polymers for use in those applications. Careful tuning of the antimicrobial polymers hydrophilic/hydrophobic balance (amphiphilicity) significantly impacts their activity and selectivity. This can be achieved by the appropriate choice of the alkylating agent to be reacted with the monourea diamine compound, resulting in new cationic polymers comprising the repeating unit of formula I.

Another subject matter of the invention is thus the preparation process of the above polymers comprising the repeating unit of formula I, said process comprising a step (i) of reacting a compound of formula II:

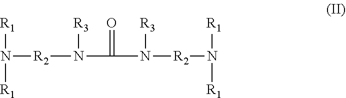

wherein
R₁ are each independently a hydrogen atom, a C₁ to C₄ alkyl or hydroxyalkyl group, or a C₂ to C₄ alkenyl group;
R₂ are each independently a C₂ to C₁₀ alkylene group;
R₃ are each independently a hydrogen atom, a C₁ to C₄ alkyl or hydroxyalkyl group, or a C₂ to C₄ alkenyl group;
with a compound of formula III:

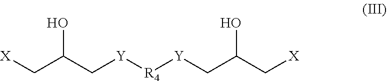

wherein
R₄ represents an oxyalkylene group of formula A:

(—CHR₅CH₂)ₐ-(OCH₂CHR₆)_{b}-(OCH₂CHR₇)_{c}-OCH₂CHR₈)_{d} (A)

wherein
“a” represents 1;
“b” represents an integer of 1 or more;
“c” and “d” represent independently from one another an integer of 0 or more; and
R₅, R₆, R₇ and R& represent independently from one another a hydrogen atom or a C₁ to C₄ alkyl group;
Y represents an oxygen atom, —NR₉- or —N⁺R₁₀R₁₁- wherein:

R₉ represents a hydrogen atom or a radical deriving from any electrophilic compound present in the reaction mixture during the synthesis process of the polymer of the invention and that reacted by alkylation reaction with a secondary amine (Y=—NH—) present on the polymer of the invention during its synthesis; and

R₁₀ and R₁₁ represent radicals deriving from any electrophilic compounds present in the reaction mixture during the synthesis process of the polymer of the invention and that reacted by successive alkylation reactions with a secondary amine (Y=—NH—) and then a tertiary amine (e.g. Y=—NR₁₀-) present on the polymer of the invention during its synthesis;
X represents an electrophilic group, preferably selected from halogens or sulfates.

The synthesis strategy permits to use inexpensive, commercially available raw materials. The process of the invention is a step-growth polycondensation process that gives access to modest molecular weights thus enabling the polymers to be soluble/processable for subsequent potential post functionalization. Importantly, the process of the invention is perfectly viable in bulk polymerization conditions or in highly concentrated water solutions, which helps to mitigate the cost, and reduce solvent waste. The process of the invention gives total or almost total conversions of the raw materials and gives possibility to eliminate polymer purification and isolation steps.

Another advantage of the invention is that amphoteric structures can be obtained from Jeffamine type based di-halogen alkylating agents. The amine groups (secondary or tertiary) present in the alkylating agent molecule give the possibility to make post polymerization functionalization with anionic alkylating agents. As example, when the sodium monochloroacetate (SMCA) is used for post polymerization functionalization of the residual amine groups of the new cationic polymer comprising repeating units of formula I, cationic and carboxybetaine functionalities can be formed on the same polymer chain backbone. It is known that the carboxybetaine type molecules possess low ecotoxic profile and are very useful in home and personal care (HPC) applications.

A large scope of chemistry is possible for the polymer comprising repeating units of formula I due to newly elaborated alkylating agents. Without being bond by any theory, it is the inventors' understanding that the expected lower ecotoxicity of the new cationic polymers according to the invention is due to lower charge density. Indeed, it is believed that lower and fine tunable charge density of the new cationic polymers according to the invention is possible thanks to using new alkylating agents of higher molecular weight especially when they are based on PEG and Jeffamine type molecules.

Another advantage of the polymers comprising the repeating unit of formula I is that they can be at least partly bio-based and/or can be produced according to a sustainable production process. Indeed, the urea compound of formula II which is used to produce the polymers comprising the repeating unit of formula I, can be prepared from urea compound of formula V: NH₂CONH₂ (V) being largely used in agrochemical applications and being produced according to a sustainable one-step electrochemical method based on the reaction between nitrogen gas and carbon dioxide in the presence of special catalysts as described in the recent publication Chen, C., Zhu, X., Wen, X. et al. Coupling N₂ and CO₂ in H₂O to synthesize urea under ambient conditions. Nat. Chem. 12, 717-724 (2020). https://doi.org/10.1038/s41557-020-0481-9). Also, the compounds of formula III, used to produce the polymers comprising the repeating unit of formula I, may for example be prepared from compounds of formula VI described later on in this text being notably polyethylene glycol and polypropylene glycol or their copolymers which are typically obtained through polymerization of ethylene oxide and propylene oxide, that may be bio-based. Moreover, Bio-based Epichlorohydrin (EPI) (which may constitute the compound of formula VII described later on in this text) is produced by using 100% renewable Glycerin which is a by-product from the transformation of vegetable oils, instead of propylene of petrochemical origin. It is a drop-in for traditional EPI and offers significant environmental advantages.

Another advantage of the invention is that most of the cationic polymers comprising the repeating unit of formula I can be formulated in surface treatment compositions that contain anionic surfactants. Indeed, the cationic polymers of the invention can be such that they do not precipitate with the said anionic surfactants present in the compositions and hence the intrinsic performance of the cationic polymers of the invention as well as the performance of the compositions (e.g. the cleaning performance) are not adversely affected.

Another advantage of the invention is that the cationic polymers comprising the repeating unit of formula I can be formulated in surface treatment compositions to provide soil release benefits e.g. to fabrics in laundry compositions and to hard surfaces in hard surface cleaning compositions.

Therefore, another subject matter of the invention is the use of the polymers in home and personal care applications, or in industrial and institutional cleaning applications.

A further subject matter of the invention is a formulation comprising:
(i) a polymer comprising the repeating unit of formula I according to the invention or obtained by the process according to the invention;
(ii) and an adjuvant selected from a surfactant and/or a thickening agent.

Various specific advantages and possible embodiments of the invention will now be described in more details.

### DETAILED DESCRIPTION

### Definitions

Throughout the description, including the claims, the term “comprising”, “comprising one” or “comprising a” should be understood as being synonymous with the term “comprising at least one”, unless otherwise specified. The terms “between” and “from . . . to . . . ” should be understood as being inclusive of the limits.

The articles “a”, “an” and “the” are used to refer to one or to more than one (i.e., to at least one) of the grammatical object of the article.

It should be noted that in specifying any range of concentration, molar or weight ratio or amount, any particular upper concentration, molar or weight ratio or amount can be associated with any particular lower concentration, molar or weight ratio or amount, respectively.

As used herein, the term “alkyl” means a saturated hydrocarbon radical, which may be straight, branched or cyclic, such as, methyl, ethyl, n-propyl, iso-propyl, n-butyl, sec-butyl, t-butyl, pentyl, n-hexyl, cyclohexyl.

As used herein, the terminology “Cx-Cxx” in reference to any organic group, wherein x and xx are each integers, indicates that the group may contain from x carbon atoms to xx carbon atoms per group.

As used herein, the term “hydroxyalkyl” means an alkyl radical, which is substituted with a hydroxyl groups, such as hydroxymethyl, hydroxyethyl, hydroxypropyl, and hydroxydecyl.

Structure of the Polymer Comprising the Repeating Unit of formula I

According to the repeating unit of formula I present on the polymer of the invention, it can be seen that when Y is NR₉, R₉ can be H or a radical resulting from an alkylation reaction between a secondary amine (Y=—NH—) present on the repeating unit of formula I during the synthesis of the polymer of the invention and any electrophilic compound, preferably a halogenoalkyl or an alkyl sulfate compound, present in the reaction mixture during the synthesis process of the polymer comprising the repeating unit of formula I.

When Y is —N⁺R₁₀R₁₁- group, R₁₀ and R₁₁ are radicals resulting from successive alkylation reactions with first a secondary amine (Y=—NH—) and then tertiary amine (e.g. Y=—NR₁₀-) present on the repeating unit of formula I during the synthesis process of the polymer of the invention and any electrophilic compounds, preferably halogenoalkyl or alkyl sulfate compounds, present in the reaction mixture during the synthesis process of the polymer according to the invention. Indeed, the secondary amine (Y=—NH— group), as it is the secondary amine group deriving from reacted Jeffamine primary amine group, can react with any halogeno alkyl or alkyl sulfate compound present in the mixture. The resulted tertiary amine group can further react with any halogeno alkyl or alkyl sulfate compound present in the mixture to form quaternary ammonium group. Halogen/Sulfate group can be from intermediate polymer chain ends or from starting raw material. The resulting polymer comprising the repeating unit of formula I can be thus more or less branched/reticulated. This reticulation/Branching is controllable via the molar ratio of the compounds used in the synthesis and through process conditions also (applied temperature, batch versus semi continuous for example).

Furthermore, the amine groups (secondary or tertiary) present in the polymer comprising the repeating unit of formula I give the possibility to make post polymerization functionalization with any further anionic alkylating agent. As example, sodium monochloroacetate (SMCA) can be used for post polymerization functionalization of the residual amine groups of the new cationic polymer comprising the repeating unit of formula I, forming then cationic and carboxybetaine functionalities on the same polymer chain backbone.

A non limiting example of a structure of the polymer of the invention in which Y is NR₉ is given below:

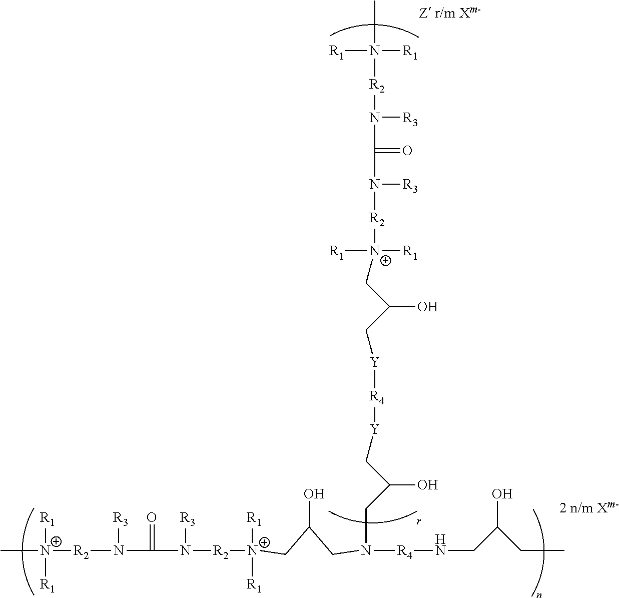

R₁, R₂, R₃, R₄ as well as Y, n, m, X have the same meaning as previously defined. “r” is an integer of 1 or more (preferably 1 to 20) and in this formula Z is 2 and Z′ is an integer between 2 and 4.

Another non-limiting example of a structure of the polymer of the invention in which one Y is NR₉ and the other is —N⁺R₁₀R₁₁ is given below.

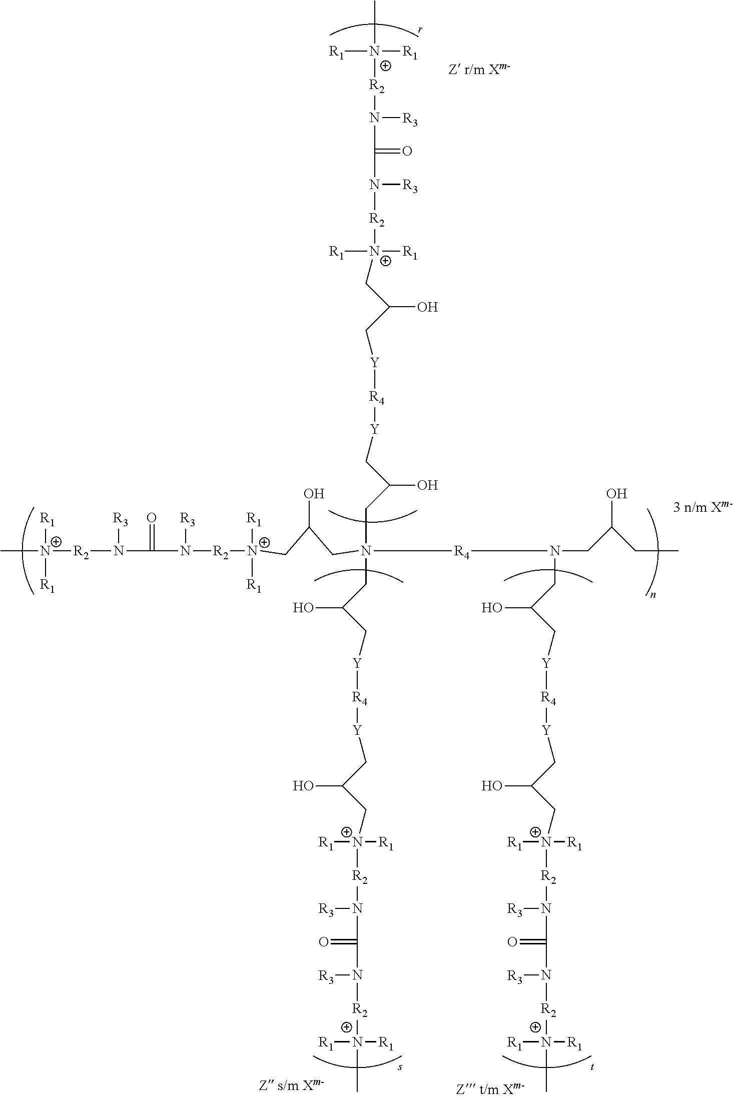

R₁, R₂, R₃, R₄ as well as Y, n, m, X have the same meaning as previously defined. “r”, “s” and “t” are integers of 1 or more (preferably 1 to 20) and in this formula Z is 3, and Z′, Z″ and Z′| are integers between 2 and 4.

For sake of clarity, Z is 2 when Y is not a quaternary ammonium. Z is 3 when one of the Y is a quaternary ammonium and Z is 4 when both Y are quaternary ammonium.

Z thus is a factor that is going to be multiplied by the ratio n/m to provide the exact number of counterion X^{m-} necessary to reach the neutrality of the polymer of formula I, wherein m is the valency of the anion and n is the number of repeating units of formula I.

The same reasoning applies to Z′, Z″ and Z′″ and all potential additional Z groups that would result from a reticulation on the repeating unit of formula I.

The polymer according to the invention is preferably such that in formula I:
R₁ are C₁ alkyl groups, i.e methyl groups;
R₂ are C₂ or C₃ alkylene group; and
R₃ are hydrogen atoms.

According to a preferred embodiment, the polymer according to the invention is such that in formula I:
R₄ represents an oxyalkylene group of formula A:

(—CHR₅CH₂)ₐ-(OCH₂CHR₆)_{b}-(OCH₂CHR₇)_{c}-(OCH₂CHR₈)_{d} (A)

wherein
“a” represents 1;
“b” represents an integer of 1 or more, preferably less than 70;
“c” and “d” represent independently from one another an integer of 0 or more, preferably less than 70; and
R₅ is methyl or hydrogen, R₆ is hydrogen, R₇ is hydrogen or methyl and R₈ is methyl group; and
Y represents an oxygen atom.

In an advantageous embodiment, the polymer according to the invention is such that, in formula I:
n represents a positive integer from 1 to 50;
m is 1; and
X is Cl.

It is particularly preferred that the polymer according to the invention has a weight average molecular weight ranging from 1 to 100 kg/mol, preferably 2 to 50 kg/mol.

In a specific embodiment, the polymer is characterized by a cationic charge density. The cationic charge density expressed in mmol/g is calculated as a ratio of the quantity of the moles of the amine groups in the mono urea di-amine compound of formula II (in mmol) and the sum of the masses (in g) of the mono urea compound of formula Il with the alkylating compound of formula III. It is particularly preferred that the polymer according to the invention has a cationic charge density ranging from 0.1 to 4.25 mmol/g, preferably 0.6 to 3.9 mmol/g.

The polymer comprising the repeating unit of formula I, depending on the ratio of the reagents used, can be terminated with tertiary amine groups, with halogenoalkyl groups, hydroxyl groups or other groups resulting from post polymerization polymer modification reaction of the previously mentioned terminating groups.

### Molar Mass Determination Method

In the present patent application, unless otherwise indicated, when reference is made to molar mass (or molecular weight), it will relate to the absolute weight-average molar mass, expressed in g/mol.

The mass distribution of the polymer is measured by SEC MALS analysis (SEC: Size Exclusion Chromatography—MALS: Multi-Angle Laser Scattering) in order to obtain the real values, expressed in g/mol. Light scattering is an absolute technique, meaning that it does not depend on any calibration standards or calibration curves (M. W. Spears, The Column 12 (11), 18-21 (2016)).

The SEC MALS analysis is performed with an HPLC chain equipped with 2 detectors: Differential refractometer RI—the concentration detector and MALS detector (Multi-Angle Laser Scattering)—the mass detector. The software records the chromatograms of the detectors:-one for the RI detector, and one for each angle of the MALS detector.

For each slice of the chromatograms (for the polymeric species), the software calculates: the concentration of the polymer (RI signal=constant*dn/dc*concentration) and the mass Mi of the slice.

From particular Mi data, the software calculates the mass distribution: Mw, Mn and polydispersity index Ip=Mw/Mn.

The calculation of the molar masses requires the refractive index increment, dn/dc of the polymer. It is a constant, depending on the nature of the mobile phase, the temperature of the experimental conditions and the wavelength of the laser, among others.

This constant can be measured according to the eluted fraction from the SEC MALS analysis with a refractometer.

For the polymers of the present patent application, “dn/dc” is calculated by the software according the mass recovery of the eluted fraction: the applied dn/dc=0.17 mL/g leads from about 90 to 100% wt. mass recovery. For examples polymers, the molar mass were calculated based on the real Mi points, without any adjustment of the log (M) curve.

Detailed Analysis conditions are as follows:
Analysis instrument: SEC system with MALS detector (Mini Dawn Heleos) and Agilent Differential Refractometer (RI)
Pump: Agilent 1100
Mobile phase: mixture of 80% water with 0.1 M NaNO₃, 200 ppm pDADMAC and 20% CH₃CN with pH=3
Column (maker, model no.): Shodex OHpak SB 806M HQ (guard column with 3 columns of 30 cm)
Temperature: 35° C.
Flow rate: 1.0 mL/min
Injection amount and Sample concentration: 100 μL, 0.1% (expressed in dry polymer)
Data processing: ASTRA 7 (Wyatt)

### Preparation of the Polymer Comprising the Repeating Unit of Formula I

The polymer comprising the repeating unit of formula I as described above is typically obtained by a process comprising a step (i) of reacting a compound of formula II:

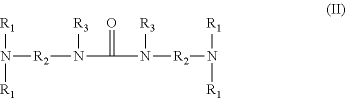

wherein
R₁ are each independently a hydrogen atom, a C₁ to C₄ alkyl or hydroxyalkyl group, or a C₂ to C₄ alkenyl group;
R₂ are each independently a C₂ to C₁₀ alkylene group;
R₃ are each independently a hydrogen atom, a C₁ to C₄ alkyl or hydroxyalkyl group, or a C₂ to C₄ alkenyl group;
with a compound of formula III:

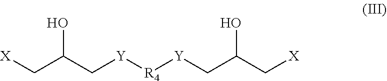

wherein
R₄ represents an oxyalkylene group of formula A:

(—CHR₅CH₂)ₐ-(OCH₂CHR₆)_{b}-(OCH₂CHR₇)_{c}-(OCH₂CHR₈)_{d} (A)

wherein
“a” represents 1;
“b” represents an integer of 1 or more, preferably up to 70;
“c” and “d” represent independently from one another an integer of 0 or more, preferably up to 70; and
R₅, R₆, R₇ and R₈ represent independently from one another a hydrogen atom or a C₁ to C₄ alkyl group;
Y represents an oxygen atom, —NR₉- or —N⁺R₁₀R₁₁- wherein

R₉ represents a hydrogen atom or a radical deriving from any electrophilic compound present in the reaction mixture during the synthesis process of the polymer of the invention and that reacted by alkylation reaction with a secondary amine (Y =-NH-) present on the polymer of the invention during its synthesis; and

R₁₀ and R₁₁ represent radicals deriving from any electrophilic compounds present in the reaction mixture during the synthesis process of the polymer of the invention and that reacted by successive alkylation reactions with a secondary amine (Y=—NH—) and then a tertiary amine (e.g. Y=—NR₁₀-) present on the polymer of the invention during its synthesis;
X represents an electrophilic group, preferably selected from halogens or sulfates.

In the process of the invention, the molar ratio between the compound of formula II and the compound of formula III is ranging from 0.75 to 1.25, preferably from 0.9 to 1.1 and more preferably from 0.95 to 1.05.

The compound of formula Il is advantageously prepared by reaction of a diamine of formula IV below:

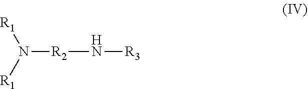

wherein R₁, R₂ and R₃ are as defined previously for formula II;
with urea of formula V: NH₂CONH₂ (V), in a molar ratio IV:V of at least 1.5 mol of the compound IV to 1 mol of compound V.

It is preferred that the molar ratio IV:V ranges from 1.5 to 2.25, preferably from 1.75 to 2.1 and more preferably from 1.95 to 2.05 mol of the compound IV to 1 mol of compound V.

It is particularly preferred that the compound of formula IV is dimethylaminopropylamine (DMAPA), meaning that R₁ are both methyl groups, R₂ is —(CH₂)₃- and R₃ is hydrogen.

In a particular embodiment of the process of the invention, the compound of formula III is prepared by reaction of a bifunctional compound of formula VI:

HY—R₄—YH (VI)

wherein Y and R₄ are as defined previously for formula III;
with on oxirane containing compound of formula VII:

X—CH₂—CH(CH₂O) (VII),

wherein X is as defined previously for formula III as well, in presence of an acid catalyst and in a molar ratio VII:VI ranging from 1.8 to 2.1 of the molecule VII to 1 mol of molecule VI, preferably 2:1.

The acid catalyst usable in the reaction between the bifunctional compound of formula VI and the oxirane containing compound of formula VII can be selected among triflic acid, bis (trifluoromethane) sulfonamide, or BF₃ in acetic acid.

It is particularly preferred that the compound of formula VII be epichlorohydrin (EPI), that is to say X is chloride.

Regarding the compound of formula VI, it can be a polyalkylene glycol based diol, notably polyethylene glycol based diol (PEG diol), i.e. Y is an oxygen atom. In particular, such a PEG diol can be selected among: polyethylene glycol with preferred Mn being in the range of approximately from 100 to 3000 g/mol, and polypropylene glycol with preferred Mn being in the range of approximately from 100 to 3000 g/mol, and poly (ethylene/propylene) glycol copolymers of random and/or block nature with preferred Mn being in the range of approximately from 100 to 3000 g/mol, and poly (propylene-co-ethylene-co-propylene) glycol multi block copolymers with preferred Mn being in the range of approximately from 150 to 3000 g/mol, and poly (ethylene-co-propylene-co-ethylene) glycol multi block copolymers with preferred Mn being in the range of approximately from 150 to 3000 g/mol.

The preferred PEG diol are Polyethylene glycol of Mn around 200 and 600, and 1500.

Alternatively, the compound of formula VI can be a Jeffamine compound, i.e. Y is NR₉ with R₉ is H. In particular, such a Jeffamine can be selected among the Jeffamine-diamines and mixture of Jeffamine-diamines with Jeffamine-multiamines as available from Huntsman Company. Not limited examples are Jeffamine ED-600, ED-900, ED-2003, EDR, D-230, D-400, D-2000).

### Example of Process Conditions

In the process of the invention, the polymer comprising repeating units of formula I is generally synthetized in standard reactor equipped with temperature control heating system, a lid containing multiple entries with installed a reflux system, a mechanical stirring system, a nitrogen purge line and a raw materials feed line. A stream of nitrogen is usually introduced into the reactor to prevent the oxidation of the reaction mixture and its discoloration. The synthesis is generally done in water solvent to achieve the final product solid content of about 30%-70%. The mono urea di-amine compound can be placed in batch manner into the reactor as initial charge. Adequate alkylating agent (ex. di-halogen compound) is preferably introduced in semi-continuous manner to better control the exothermic effect of the reaction and to limit the branching reactions. The reaction is usually done under efficient stirring and under atmospheric pressure. The reaction temperature can range from 70 to 100° C., preferred 100° C. Typical reaction time is around 8 hours. The reaction product is generally a limpid to hazy viscous liquid.

In the process of the invention, the compound of formula II is generally synthetized in the standard reactor equipped with temperature control heating system, a lid containing multiple entries with installed a reflux system prolonged with the ammonia recovery line, a mechanical stirring system, a nitrogen purge line, a raw materials feed line and a recovery flask to collect eventual amine condensates carried away with ammonia gas. A stream of nitrogen can be used to prevent the oxidation of the reaction mixture and its discoloration. The reagents are usually introduced into the reactor at batch manner at the beginning of the process, without any solvent. Stirring and heating are preferably maintained for around 10-15 hours at atmospheric pressure. At this step, the reaction is typically done at 2 temperatures, at the begging at around 110-130° C., then 145° C.-155° C. During all heating time the ammonia can be trapped in water flasks. When no more ammonia flow is observed the assembly can be placed under vacuum at around 350-550 mmHg at 145-155° C. for around 2 hours to recover the remaining in the reactor ammonia and not reacted di-amine raw materials. The vacuum can be then broken and the assembly can be cooled to ambient temperature. The product is typically liquid at room temperature.

In the process of the invention, the compound of formula III can be synthetized in the standard reactor equipped with temperature control heating system, a lid containing multiple entries with installed a reflux system, a mechanical stirring system, a nitrogen purge line and a raw materials feed line. To ensure a total conversion of the reagents at reasonable times optionally a catalyst can be used being adequate Bronsted and Lewis acid. Typically raw material of formula VI and catalyst are added in batch manner at the beginning of the reaction, and the reagent of the formula VII is feeded at semi-continuous manner for better control the reaction exothermic effect and the possible branching reactions. The reaction can be done under atmospheric pressure. The reaction temperature is typically ranging from 25 to 60° C. for better control of the possible branching. The reaction can be done in bulk without any solvent. The final product can be from a liquid to a wax like product.

Uses of the Polymer Comprising the Repeating Unit of formula I

The polymer comprising repeating units of formula I of the present invention is usable in many surface treatment applications, notably in home and personal care applications (fabrics, hair, hard surfaces, toilets, etc.)), but also in Industrial applications like lubricant for metal treatment, or binder between metal and organic coatings.

Other uses of the polymer comprising the repeating unit of formula I are agrochemical formulations and coatings formulations.

In particular, the present invention is targeting the use of the polymer according to the invention, as anti-microbial agent in
a. laundry compositions, including but not limited to:
   i. laundry detergent compositions;
   ii. rinse-added laundry compositions such as fabric softener, laundry sanitizer;
   iii. ancillary laundry compositions;
   iv. fabric care compositions such as fabric freshener, fabric spray
b. hard surface cleaning compositions, including but not limited to:
   i. floor cleaning compositions
   ii. toilet or bathroom cleaning compositions
   iii. toilet bowl cleaning compositions
c. dish wash cleaning compositions such as hand dish wash and automatic dish wash compositions.
d. hair care compositions such as shampoo and conditioning compositions.

By “anti-microbial agent” it is understood that it is an agent that capable of killing or inhibiting the growth of microorganisms.

By “Ancillary laundry compositions”, it is understood that it means compositions intended to be used in addition to the consumer's regular laundry products (laundry detergent, softener). For example in addition to a wash detergent and/or rinse added fabric conditioners. The ancillary laundry composition may be added into the wash liquor at any point in the wash cycle.

The present invention is also directed to the use of the polymer according to the invention, as dye fixing agent or transfer inhibitor agent or soil anti-redeposition agent or soil release agent or laundry additives deposition agent in laundry compositions. In case of laundry additive deposition agent, the laundry additive can be for example a fabric care polymer, a fragrance oil, or an encapsulated perfume.

Also, the present invention is directed to the use of the polymer according to the invention, as soil anti-redeposition agent or soil release agent or shining agent in dish wash compositions.

Formulations Comprising the Polymer Comprising Repeating Units of formula I

The present invention is also directed to a formulation comprising:
(i) a polymer as defined above;
(ii) and an adjuvant selected from a surfactant and/or a thickening agent.

Indeed, as explained previously, the formulation of the present disclosure comprising the polymer comprising repeating units of formula I is suitable for a variety of consumer applications.

In one embodiment of the present disclosure, the formulation is a homecare formation or personal care formulation. Examples of the formulations of the invention include, but are not limited to, surface cleaners such as those intended for use in bathrooms, kitchens, living areas, hard floor cleaners, carpet cleaners, furniture cleaners, glass/mirror cleaners; toilet care products including solid toilet cleaners such as rim devices and those designed to be placed in the cistern, liquid toilet cleaners excluding those comprising hypochlorite bleaches; dishwashing products such as washing up liquids and preparations from dishwashing machines such as dishwashing solids (e.g. powders and tablets) & liquids; laundry products such as solid detergents (e.g. powders and tablets), liquid detergents and fabric conditioners and “2 in 1” products comprising detergent and fabric conditioner; cleaning products intended for use outdoors such as those for cleaning for wood, stone, concrete or plastics, for example patio cleaner, garden furniture cleaners/treatments, BBQ cleaners, wall and fence cleaners/treatments, plant sprays such as those intended to remove insects such as aphides from plants; food sprays, such as those suitable for use in food preservation; personal care products such as bath and shower products; soaps, including liquid and solid soaps, hand sanitizers, deodorants and antiperspirants, haircare products including shampoos, for example anti-scalp odour shampoos, shampoos for the control of head lice eggs and anti-dandruff shampoos, hair conditioners, hair styling products such as hair mousses, gels and sprays, skin care products such as shaving products, cosmetics and products for hair removal; baby products including baby cleaning and cleansing products such as baby bath, soaps, wipes, moisturizers, nappy rash cream, products for cleaning surfaces that have regular & high incidence of infant & baby contact; first aid products and products for treating ailments and illnesses, including products for the topical treatment and/or prevention of minor infections such as athletes foot, spot/acne prevention/treatment products; foot hygiene products, including those for use on the foot and those for the treatment/deodorization of foot ware, particularly sports foot wear; products for cleaning and/or deodorizing vehicles such as cars.

In one aspect of the present disclosure, the formulation is a laundry detergent composition, comprising:
i) the polymer comprising repeating units of formula I as illustrated above; and
ii) a surfactant that can be selected from cationic surfactant, anionic surfactant, non-ionic surfactant, amphoteric surfactant or the combination thereof.

The laundry detergent composition can be in a form of liquid or solid.

Suitable non-ionic surfactants for use as the formulation surfactant include but are not limited to ethylene oxide/propylene oxide block polymers, polyethoxylated sorbitan esters, fatty esters of sorbitan, ethoxylated fatty esters (containing from 1 to 25 units of ethylene oxide), polyethoxylated C₈-C₂₂ alcohols (containing from 1 to 25 units of ethylene oxide), polyethyoxylated C₆-C₂₂ alkylphenols (containing from 5 to 25 units of ethylene oxide), alkylpolyglycosides. Examples include but are not limited to nonyl phenol ethoxylate (9EO), Nonyl phenol ethoxylate (2EO), octyl phenol ethoxylate (10EO), C₁₂/C₁₄ synthetic ethoxylate (8EO), stearyl alcohol ethoxylate (7EO), cetostearyl alcohol ethoxylate (20EO), coconut fatty amine ethoxylate (10EO), sorbitan monolaurate ethoxylate, 80% PO/20% EO, coconut diethanolamide (shampoo foam booster), sorbitan monolaurate, sorbitan monolaurate 4EO, di-isopropyl adipate, alkyl poly glucosides, such as C₆-20, preferably C₈₋₁₀ alkyl glucosides, eg Surfac APG (D-Glucopyranose oligomers C₈₋₁₀ alkyl glucosides, CAS 161074-97-1, available from Seppic, UK), and cetostearyl stearate. Other suitable non-ionic surfactants include Neodol 25-7 (C_{12/15} alcohol 7 ethoxylate (EO), CAS 68131-39-5), Surfac LM90/85 (C_{12/15} alcohol 9 ethoxylate (EO), CAS 68131-39-5), Surfac 65/95 (C_{9/11} alcohol 6.5 ethoxylate (EO), CAS 68439-45-2), Tomadol PF9 (C_{9/11} alcohol 6.0 ethoxylate (EO), CAS 68439-46-3), Surfac T80 Veg (Polysorbate 80, Polyoxyethylene sorbate mono oleate, CAS 9005-65-6), Tween 60 (Polysorbate 60, Polyoxyethylene sorbate mono stearate, CAS 9005-67-8), Tween 40 (Polysorbate 40, Polyoxyethylene sorbate mono palmitate, CAS 9005-66-7), Surfac T-20 (Polysorbate 20, Polyoxyethylene sorbate mono laurate, CAS 9005-64-5), Surfac PGHC (Hydrogenated Castor oil 40EO, CAS 61788-85-0), Ninol 49-CE (Coconut diethanolamide, CAS 68603-42-9).

The anionic surfactants contemplated in the present disclosure as surface-active agent comprise the major active components in conventional detergent systems, including any of the known hydrophobes attached to a carboxylate, sulphonate, sulfate or phosphate polar, solubilizing group including salts. Salts may be the sodium, potassium, ammonium and amine salts of such surfactants. Useful anionic surface-active agents can be organic sulfuric reaction products having in their molecular structure an alkyl group containing from about 8 to about 22 carbon atoms and a sulfonic acid or sulfuric acid ester group, or mixtures thereof. (Included in the term “alkyl” is the alkyl portion of acyl groups.) Examples of this group of synthetic detersive surfactants which can be used in the present disclosure are the alkyl sulfates, especially those obtained by sulfating the higher alcohols (C₈-C₁₈ carbon atoms) produced from the glycerides of tallow or coconut oil; and alkyl benzene sulphonates.

Other useful anionic surface-active agents herein include the esters of alpha-sulphonated fatty acids preferably containing from about 6 to 20 carbon atoms in the ester group; 2-acyloxyalkane-1-sulfonic acids preferably containing from about 2 to 9 carbon atoms in the acyl group and from about 9 to about 23 carbon atoms in the alkane moiety; alkyl ether sulfates preferably containing from about 10 to 20 carbon atoms in the alkyl group and from about 1 to 30 moles of ethylene oxide; olefin sulphonates preferably containing from about 12 to 24 carbon atoms; and beta-alkyloxy alkane sulphonates preferably containing from about 1 to 3 carbon atoms in the alkyl group and from about 8 to 20 carbon atoms in the alkane moiety.

Specific preferred anionics for use herein include: the linear C₁₀-C₁₄ alkyl benzene sulphonates (LAS); the branched C₁₀-C₁₄ alkyl benzene sulphonates (ABS); the tallow alkyl sulfates, the coconut alkyl glyceryl ether sulphonates; the sulfated condensation products of mixed C₁₀-C₁₈ tallow alcohols with from about 1 to about 14 moles of ethylene oxide; and the mixtures of higher fatty acids containing from 10 to 18 carbon atoms.

It is to be recognized that any of the foregoing anionic surfactants can be used separately herein or as mixtures. Moreover, commercial grades of the surfactants can contain non-interfering components which are processing by-products. For example, commercial alkaryl sulphonates, preferably C₁₀-C₁₄, can comprise alkyl benzene sulphonates, alkyl toluene sulphonates, alkyl naphthalene sulphonates and alkyl poly-benzenoid sulphonates. Such materials and mixtures thereof are fully contemplated for use herein.

In another aspect of the present disclosure, the formulation is a sanitizer composition, comprising:
i) the polymer comprising the repeating units of formula I as illustrated above; and
ii) a thickening agent.

Preferred thickening agents used in the formulation of the present disclosure are commercially available fully synthetic thickeners based on acrylic acid copolymers, methacrylic acid copolymers, vinyl polymers, polycarboxylic acids, polyimines, polyamides natural and polyethers. In addition, thickening agents such as guars, carboxymethylcelluloses, cellulose ethers, xanthans, locust bean gum may be used, which are optionally modified by suitable chemical reactions, possibly even in view of their specific use in connection with the present disclosure. The foregoing components may be used either alone or in combinations thereof.

Illustrative examples of commercially available thickeners is a polymeric thickening agent sold under the name Jaguar HP105, distributed by Solvay.

In yet another aspect of the present disclosure, it is provided the use of the polymer comprising the repeating units of formula I or a formulation comprising it, as illustrated above, for substantially reducing or controlling the formation of microbial colonies on or at the surface.

In still another aspect of the present disclosure, it is provided the use of the polymer comprising the repeating units of formula I or a formulation comprising it, as illustrated above, for controlling malodor.

The following examples illustrate the invention.

### EXAMPLES

### A. Raw Materials

Table 1 below shows the reagents used in the examples and its abbreviations. All reagents used were purchased from Sigma Aldrich.

TABLE 1
Raw materials used in the experimental part.

| Product | Abbreviation | CAS |
|---|---|---|
| Urea | — | 57-13-6 |
| Dimethylaminopropylamine | DMAPA | 109-55-7 |
| Polyethylene glycol of Mn around | PEG 200, 600, 1500 | 25322-68-3 |
| 200 and 600, and 1500 g/mol | | |
| Jeffamine ED-600, ED-900, D-400 | JFA ED-600, ED-900, | 83713-18-5 |
| | D-400 | |
| Bis(chloroethyl) ether | DCE1 | 111-44-4 |
| Epichlorohydrin | EPI | 106-89-8 |
| Triflic acid | TA | 1493-13-6 |
| Polyquaternium-2 polymer | PQ-2 | 68555-36-5 |

### B. Di-Chloro Compounds Synthesis

Di-Chloro Compounds from PEG and EPI

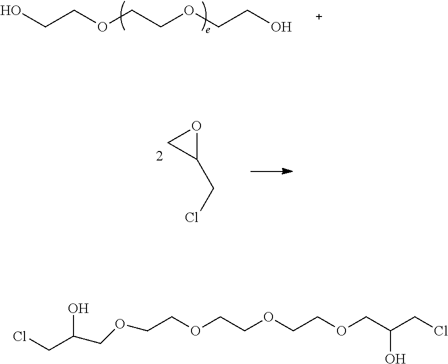

All di-chloro compounds were synthetized according to the same process. The whole synthesis is conducted in a reactor equipped with temperature control heating system, a lid containing multiple entries with installed a reflux system, a mechanical stirring system, a nitrogen purge line and a raw materials feed line. To ensure a total conversion of the reagents at reasonable times the TA catalyst was used

Adequate PEG was weighed and transferred to the purged with nitrogen reactor. The catalyst was then added to the reactor in a one shot manner. The reaction mixture was heated to 40° C. (or to 50° C. in case of the PEG1500) and stirred for 12 hours. During the first two hours of the heating the epichlorohydrine was added semi-continuously using a syringe type pump. The temperature was controlled by cryothermostat type bath.

The reaction completion was followed with 13C NMR analyses which indicated that the EPI and PEG were converted into target di-chloro compounds.

The quantities of the reagents used for the particular examples are provided in Table 2 below and the conversion results of the reaction is provided in Table 3 below.

TABLE 2
Reagents quantities used for PEG and EPI
based di-chloro compounds synthesis.

| | | | | | Catalyst |
|---|---|---|---|---|---|
| | Reagent 1 | | Reagent 2 | | (Triflic acid, TA) |
| Example | Type | grams | Type | grams | grams |
| Example 1 | PEG 200 | 67.3 | EPI | 62.2 | 0.50 |
| Example 2 | PEG 1500 | 115.6 | EPI | 14.3 | 0.15 |
| Example 3 | PEG 600 | 98.5 | EPI | 30.5 | 0.50 |

TABLE 3
Conversion results for the PEG/EPI
di-chloro compounds synthesis.

| | | | Conversion of | |
|---|---|---|---|---|
| Example | Catalyst | T° C. | EPI (¹H NMR) | Comment |
| Example 1 | Triflic | 40 | 100% | Desired product obtained, |
| | acid | | | reaction mixture transparent |
| | | | | and nearly colorless |
| Example 2 | Triflic | 50 | 100% | Desired product obtained, |
| | acid | | | 50° C. due to solid form |
| | | | | of PEG1500 at 40° C.; |
| | | | | reaction mixture |
| | | | | transparent |
| | | | | and nearly colorless |
| Example 3 | Triflic | 40 | 100% | Desired product obtained, |
| | acid | | | reaction mixture transparent |
| | | | | and nearly colorless |

Conclusion: a total conversion of the EPI was obtained.

Di-Chloro Compounds from JFA and EPI

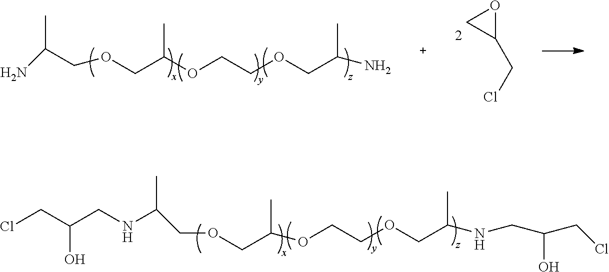

All di-chloro compounds were synthetized according to the same process. The whole synthesis is conducted in a reactor equipped with temperature control heating system, a lid containing multiple entries with installed a reflux system, a mechanical stirring system, a nitrogen purge line and a raw materials feed line. None catalyst addition was needed to convert the EPI and Jeffamine into desired di-chloro compounds.

Adequate JFA was weighed and transferred to the purged with nitrogen reactor. The reaction mixture was heated to 40° C. and stirred for 6 hours. During the first two hours of the heating the epichlorohydrine was added semi-continuously using a syringe type pump. The exothermic effect was controlled by cryothermostat type bath.

The reaction completion was followed with 13C NMR analyses. The EPI and JFA were converted into target di-chloro compounds. The branching alkylation reaction of the resulted secondary amine with the chloro compounds present in the reaction mixture was also stated with 13C NMR analyses. The branching reaction continued during product storage up to very viscous product of gel-like form after few weeks of storage at room temperature.

The quantities of the reagents used for the particular examples are provided in the Table 4 below and the conversion results of the reaction is provided in Table 5 below.

TABLE 4
Reagents quantities used for JFA and EPI
based di-chloro compounds synthesis.

| | |
|---|---|
| Reagent 1 | Reagent 2 |

| Example | Type | grams | Type | grams |
|---|---|---|---|---|
| Example 4 | JFA ED600 | 99.4 | EPI | 30.6 |
| Example 5 | JFA ED900 | 107.8 | EPI | 22.2 |
| Example 6 | JFA D400 | 90.9 | EPI | 39.1 |

TABLE 5
Conversion results for the Jeffamine/EPI
di-chloro compounds synthesis.

| | | Conversion of EPI | | |
|---|---|---|---|---|
| Example | T° C. | (¹H NMR) | Jeffamine | Comment |
| Example 4 | 40 | 100% | ED-600 | Desired product |
| | | | | obtained, branching |
| | | | | visible on NMR |
| | | | | spectra; reaction |
| | | | | mixture transparent |
| | | | | and yellowish |
| Example 5 | 40 | 100% | ED-900 | Desired product |
| | | | | obtained, branching |
| | | | | visible on NMR |
| | | | | spectra; reaction |
| | | | | mixture transparent |
| | | | | and yellowish |
| Example 6 | 40 | 100% | D-400 | Desired product |
| | | | | obtained, branching |
| | | | | visible on NMR |
| | | | | spectra; reaction |
| | | | | mixture transparent |
| | | | | and yellowish |

Conclusion: a total conversion of the EPI was obtained.

### C. Mono Urea Di-Amine Compounds Synthesis

The Mono urea di-amine compounds were synthetized according to the same process. The whole synthesis is conducted in a reactor equipped with temperature control heating system, a lid containing multiple entries with installed a reflux system prolonged with the ammonia recovery line, a mechanical stirring system, a nitrogen purge line and a raw materials feed line. The ammonia recovery line is composed of two flasks where ammonia is trapped thanks to purging through the water. The water quantity applied corresponds to 10% wt. of ammonia concentration based on total consumption of the urea during the reaction. Another, empty recovery flask was placed between a reflux column at the outlet of the reactor and the water flask to collect eventual amine condensates carried away with ammonia gas.

To synthetize the mono urea di-amine compound the primary/tertiary amine used is DMAPA.

The molar ratios of the reagents are provided in Table 6 below and the quantities of the reagents are provided in Table 7 below.

The applied ratio of urea to amine compounds was equal to one. This ratio concerns the reacting functionalities of the urea with particular amines compounds. Thus, the molar ratio between urea and DMAPA noted respectively as x:z was kept to respect the equation x=z/2.

TABLE 6
Molar ratio of reagents used for mono
urea di-amine compounds synthesis

| Mono urea di- | Urea | DMAPA |
|---|---|---|
| amine compound | x | z |
| Example 7 | 1 | 2 |

TABLE 7
Reagents quantities used for mono
urea di-amine compounds synthesis

| Mono urea and polyurea | | |
|---|---|---|
| di-amine compound | Urea, grams | DMAPA, grams |
| Example 7 | 25.25 | 85.6 |

The general synthesis protocol of the mono urea di-amine compounds was as following:

A stream of nitrogen was introduced into the reactor to prevent the oxidation of the reaction mixture and its discoloration. The appropriate weighted quantities of the Urea and primary/tertiary amine are introduced into the reactor.

Stirring and heating are maintained for around 11 hours. The reaction is done at 2 temperatures, at the begging during first 7 hours the temperature is maintained at around 120° C., than during next 4 hours at around 145° C.-150° C. During all heating time the ammonia purge is observed at trapping water flasks.

After 11 hours of the reaction at atmospheric pressure, the assembly is placed under vacuum at around 450 mmHg at 145-150° C. for 2 hours to recover the remaining in the reactor ammonia and not reacted di-amine raw materials. The vacuum is then broken and the assembly is cooled to ambient temperature. The obtained product had a liquid form at room temperature.

Finally, the contents of the ammonia trapping flasks, of the di-amine recovery flask and of the reactor are collected separately in order to be analyzed.

The reaction yield, which is provided in Table 8 below, was calculated from water ammonia solutions amine number titration data (solutions recovered from ammonia trapping flasks). The Amine number (AN) titration is done by diluting of 0.2 to 0.3 gram of sample in 50 mL of acetic acid and titrating it against 0.1 M perchloric acid. The number of moles of perchloric acid needed to achieve the equivalency point corresponds to number of moles of the ammonia in the test sample. To calculate the reaction yield, the titrated formed during reaction ammonia is compared to overall theoretical ammonia quantity possible to be formed from applied for reaction urea quantity.

TABLE 8
Reaction yield data and product appearance
for particular synthesis examples.

| | Formed NH₃, | Reaction | Product |
|---|---|---|---|
| Mono urea di- | grams - based on | yield based | form at |
| amine | titration | on NH₃ | room |
| compound | analysis | titration data, % | temperature |
| Example 7 | 13.7 | 96% | Yellowish viscous |
| | | | liquid |

The Equivalent Molecular Weight (EMW) of the obtained mono urea compound was calculated from Amine number titration data of the final reaction mixture according to equation 1.

EMW=56100 (mg KOH/mol)/AN1 (mg KOH/g). (1)

The Amine number (AN1) titration is done as above described. The number of moles of perchloric acid needed to achieve the equivalency point corresponds to number of moles of the amine functionalities in the test sample. The Amine number is expressed in mg KOH/g of sample. Table 9 regroups the obtained data for the example 7.

TABLE 9
Amine number (AN1) and Equivalent Molecular
Weight (EMW) data obtained.

| Example | AN1 (mg KOH/g) | EMW (g/mol) |
|---|---|---|
| Example 7 | 490.4 | 114.4 |

### D. Cationic Polymers Synthesis

All cationic polymers based on di-chloro compounds were synthetized according to the same process. The whole synthesis is conducted in a reactor equipped with temperature control heating system, a lid containing multiple entries with installed a reflux system, a mechanical stirring system, a nitrogen purge line and a raw materials feed line.

A stream of nitrogen was introduced into the reactor to prevent the oxidation of the reaction mixture and its discoloration.

The weighted then diluted with water to about 35%-50% concentration mono urea di-amine compound was placed into the reactor. Adequate chlorinated alkylating agent (di-chloro compound) was weighted and transferred to syringe type feeding pump. The initial reactor content was heated to 100° C. and reaction mixture was stirred during all the synthesis process. During the first 4 hours of the heating the chlorinated alkylating agent was added semi-continuously using a syringe type pump. The exothermic effect was controlled by cryothermostat type bath. After 8 hours of heating at 100° C. the reaction mixture was cooled down to room temperature and the product was analyzed by ¹H NMR and ¹³C NMR to determine residual di-chloro compounds residual mono urea compounds, as well as Solid Content, pH, Brookfield viscosity and amine number (AN1).

For comparison aspects the “Polyquaternium-2” (PQ-2) polymer can be obtained from Aldrich being the cationic polymer of the Monourea di-amine compound with DCE1 di-halogen alkylating agent.

The molar ratio of the reagents and quantities of the reagents (calculations according to EMW which takes into account the number of reactive groups in the particular reagent) used for the particular cationic polymers synthesis examples based on mono urea di-amine compounds with various di-chloro compounds are provided in Tables 10 and 11 respectively below. The obtained products analysis characteristics are provided in Table 12 below.

TABLE 10
Molar ratio of the reagents used for cationic polymers synthesis based
on mono urea di-amine with various di-chloro compounds and the corresponding
theoretical cationic charge densities of the cationic polymers.

| | Reagent 1 | | Reagent 2 | | Cationic charge |
|---|---|---|---|---|---|
| Cationic polymer | Type | Mol ratio | Type | Mol ratio | density, mmol/g |
| Comparative | Mono urea di- | 1 | DCE1 | 1 | 5.4 |
| Example 11 | amine | | | | |
| (Polyquaternium-2) | | | | | |
| Example 12 | Mono urea di- | 1 | DCE1 and | 0.5 | 2.9 |
| | amine | | Example 4 | 0.5 | |
| | (Example 7) | | JFA ED600/EPI | | |
| Example 13 | Mono urea di- | 1 | Example 4 | 1 | 2.0 |
| | amine | | JFA ED600/EPI | | |
| | (Example 7) | | | | |
| Example 14 | Mono urea di- | 1 | Example 5 | 1 | 1.5 |
| | amine | | JFA ED900/EPI | | |
| | (Example 7) | | | | |
| Example 15 | Mono urea di- | 1 | Example 6 | 1.2 | 2.15 |
| | amine | | JFA D400/EPI | | |
| | (Example 7) | | | | |
| Example 16 | Mono urea di- | 1 | Example 1 | 1 | 3.25 |
| | amine | | PEG200/EPI | | |
| | (Example 7) | | | | |
| Example 17 | Mono urea di- | 1 | Example 3 | 1 | 2.9 |
| | amine | | PEG600/EPI | | |
| | (Example 7) | | | | |
| Example 18 | Mono urea di- | 1 | Example 2 | 1 | 1.0 |
| | amine | | PEG1500/EPI | | |
| | (Example 7) | | | | |

TABLE 11
Quantities of the reagents used for cationic polymers synthesis
based on mono urea di-amine with various di-chloro compounds.

| | | | Water, |
|---|---|---|---|
| Cationic polymer | Reagent 1, grams | Reagent 2, grams | grams |
| Comparative | Mono urea di-amine | DCE1 = 22.25 | 38.5 |
| Example 11 | (Example 7) = 35.8 | | |
| (PQ-2) | | | |
| Example 12 | Mono urea di-amine | DEC1 = 30.4 | 200 |
| | (Example 7) = 98.9 | JFA ED600/EPI Example 4 = | |
| | | 170.6 | |
| Example 13 | Mono urea di-amine | JFA ED600/EPI Example 4 = | 40.0 |
| | (Example 7) = 13.7 | 46.3 | |
| Example 14 | Mono urea di-amine | JFA ED900/EPI Example 5 = | 40.0 |
| | (Example 7) = 9.36 | 50.6 | |
| Example 15 | Mono urea di-amine | JFA D400/EPI Example 6 = | 40.0 |
| | (Example 7) = 14.4 | 53.4 | |
| Example 16 | Mono urea di-amine | PEG200/EPI Example 1 = | 40.0 |
| | (Example 7) = 21.95 | 36.35 | |
| Example 17 | Mono urea di-amine | PEG600/EPI Example 3 = | 40.0 |
| | (Example 7) = 13.8 | 46.2 | |
| Example 18 | Mono urea di-amine | PEG1500/EPI | 40.0 |
| | (Example 7) = 7.3 | Example 2 = 52.7 | |

TABLE 12
Characteristics of the final cationic polymers based on
mono urea di-amine with various di-chloro compounds.

| | | Residual | | Solid | | |
|---|---|---|---|---|---|---|
| | Residual di- | Mono urea | Amine | Content, % | Viscosity | |
| | chloro | di-amine | Number | (Gravimetric, | cP | |
| | compound | compound | AN, | 1 gram, | 20° C., | pH |
| Cationic | (GC or ¹³C | (¹H NMR or | mgKOH/g | 1 hour, | 30 rpm, | (solution |
| polymer | NMR) | HPLC) | (titration) | 115° C.) | RV#3 | as is) |
| Comparative | — | — | — | 62 | — | 8.2 |
| Example 11 | | | | | | |
| (PQ-2) | | | | | | |
| Example 12 | 0.04% | 0.7% | 56.6 | 67.0 | 3700 | 9.3 |
| Example 13 | <1% | 2.3% | 74.5 | 59.6 | 380 | 9.3 |
| Example 14 | <1% | <1% | 47.5 | 60.3 | 490 | 8.7 |
| Example 15 | <1% | 2.2% | 87.4 | 66.4 | 4300 | 8.7 |
| Example 16 | <1% | 0.6% | 17.2 | 60.1 | 200 | 10.0 |
| Example 17 | <1% | 0.3% | 2.0 | 56.8 | 720 | 8.4 |
| Example 18 | <1% | 1.3% | 11.9 | 58.7 | 220 | 9.8 |

The obtained products measured molecular weight analysis results are provided in Table 13 below.

TABLE 13
Measured molecular weight data for the final cationic polymers
based on mono urea di-amine with various di-chloro compounds.

| Cationic | Mn, | Mw | Polydispersity |
|---|---|---|---|
| polymer | g/mol | g/mol | index (Ip) |
| Comparative Example 11 | 4.0 | 8.0 | 2.0 |
| (PQ-2) | | | |
| Example 12 | | | |
| Example 13 | 3.1 | 12.0 | 3.9 |
| Example 14 | 2.7 | 14.2 | 5.3 |
| Example 15 | | | |
| Example 16 | 1.4 | 2.7 | 1.9 |
| Example 17 | | | |
| Example 18 | | | |

### E. Soil Release Performance Test in Laundry Composition.

The soil release performance was evaluated using dirty motor oil. The polymers comprising the repeating unit of formula I were formulated in concentrated liquid detergent compositions given in Table 14.

TABLE 14
Concentrated liquid detergent compositions.

| | Comp | Comp | | | |
|---|---|---|---|---|---|
| | Example 19 | Example 20 | Example 21 | Example 22 | Example 23 |
| Concentrated liquid | Part by | Part by | Part by | Part by | Part by |
| laundry composition | weight | weight | weight | weight | weight |
| Linear alkyl benzene | 10.0 | 10.0 | 10.0 | 10.0 | 10.0 |
| sulphonate, sodium | | | | | |
| salt | | | | | |
| Ethoxylated fatty | 10.0 | 10.0 | 10.0 | 10.0 | 10.0 |
| alcohol C₁₂₋₁₈ (7 EO | | | | | |
| units) | | | | | |
| Sodium fatty acid soap | 5.5 | 5.5 | 5.5 | 5.5 | 5.5 |
| (C₁₀₋₁₈) | | | | | |
| Sodium laureth | 5.0 | 5.0 | 5.0 | 5.0 | 5.0 |
| sulphate (2 EO units) | | | | | |
| Propylene glycol | 6.5 | 6.5 | 6.5 | 6.5 | 6.5 |
| Comparative | — | 1.0 | — | — | — |
| example 11 | | | | | |
| Example 12 | — | — | 1.0 | — | — |
| Example 14 | — | — | — | 1.0 | — |
| Example 17 | — | — | — | — | 1.0 |
| Water | To 100 | To 100 | To 100 | To 100 | To 100 |

The soil release performance is carried out on the following test fabrics:
Test fabric 1: 100% polyester, Style #777 from Testfabrics
Test fabric 2: 50%/50% polyester-cotton blend, Style #7422 from Testfabrics
Test fabric 3: 100% polyester, W-30A from WFK
Test fabric 4: 65%/35% polyester-cotton blend, W-20A from WFK.
Test fabric 5: 100% Cotton from, W-10A from WFK.
Test fabric 6: 100% Bleached Cotton, Interlock Knit, T-460 from Testfabrics

### Prewashing:

The test fabrics were cut into squares 7 cm×7 cm in size in three replicates and were prewashed in a Tergotometer for 20 minutes at 40°° C. with the laundry detergent compositions shown in Table 14. The water employed had a hardness of 25° FH (with Ca:Mg molar ratio=2.4:1) and the quantity of the laundry detergent compositions used was 2.5 grams per liter of water. The Tergotometer speed was set at 120 oscillations per minute.

The test fabric squares were then rinsed 3 times for 5 minutes with cold water (20° C.) and then dried.

### Soiling:

After the test fabric squares were completely dried, they were soiled using three drops of dirty motor oil (DMO) added from a 3 ml disposable pipette. The soiled test fabric squares were left overnight before washing. To allow good reproducibility of the results the soiled test fabrics squares were washed within 24 hours.

Washing:

The washing was performed in the same conditions as the prewashing in a Tergotometer for 20 minutes at 40° C. with the laundry detergent compositions shown in Table 14. The water employed had a hardness of 25° FH (with Ca:Mg molar ratio=2.4:1) and the quantity of the laundry detergent compositions used was 2.5 grams per liter of water. The Tergotometer speed was set at 120 oscillations per minute.

The test fabric squares were then rinsed 3 times for 5 minutes with cold water (20° C.) and then dried.

### Evaluation:

The test fabric squares before soiling (referred to as white), after soiling (referred to as soil) and after washing (referred to as wash) were analyzed with the ColorQuest XE reflectance colorimeter from HunterLab to measure their CIEALAB color space (L*, a*, b*).

The soil release performance of the laundry detergent compositions with the polymers comprising the repeating unit of formula I according to the present invention and of the laundry detergent composition without polymer is assessed based on the following formula:

$$Soil Removal in \% = \frac{\sqrt{Δ {L}^{2} + Δ {a}^{2} + Δ {b}^{2}}}{\sqrt{Δ {L}^{′2} + Δ {a}^{′2} + Δ {b}^{′2}}}$$

$$Where :$$

$$Δ L = {L}^{*} ( wash ) - {L}^{*} ( stain )$$

$$Δ a = {a}^{*} ( wash ) - {a}^{*} ( stain )$$

$$Δ b = {b}^{*} ( wash ) - {b}^{*} ( stain )$$

$$Δ {L}^{′} = {L}^{*} ( white ) - {L}^{*} ( stain )$$

$$Δ {a}^{′} = {a}^{*} ( white ) - {a}^{*} ( stain )$$

$$Δ {b}^{′} = {b}^{*} ( white ) - {b}^{*} ( stain )$$

The effectiveness of the soil release performance of the laundry detergent compositions with the polymers comprising the repeating unit of formula I according to the present invention is compared to the laundry detergent composition without polymer based on the following formula:

### Soil Removal With Polymer in %-Soil Removal Without Polymer in %

The effectiveness of the soil release performance of the laundry detergent compositions with the polymers comprising the repeating unit of formula I is given in Table 15 below.

TABLE 15
The effectiveness of the soil release performance of the laundry detergent
compositions with the polymers comprising the repeating unit of formula I

| Liquid | | | | | |
|---|---|---|---|---|---|
| Laundry | | | | | |
| Composition/ | Comp | Comp | Example | Example | Example |
| Test fabrics | Example 19 | Example 20 | 21 | 22 | 23 |
| Test fabric 1 | — | 0.2 | 2.47 | 7.37 | 2.9 |
| Test fabric 2 | — | −4.1 | 4.85 | 12.51 | 7.78 |
| Test fabric 3 | — | −0.65 | 2.95 | 4.38 | 3.38 |
| Test fabric 4 | — | 0.88 | 2.33 | 5.82 | 5.12 |
| Test fabric 5 | — | −1.87 | 0.99 | 0.54 | 2.34 |
| Test fabric 6 | — | −4.01 | 0.79 | 0.21 | 2.36 |
| Total | — | −9.55 | 14.38 | 30.83 | 23.88 |

As shown by the results in Table 15, the presence of the polymers comprising the repeating unit of formula I of the present invention in the laundry detergent compositions improves the soil releasing performance across different type of test fabrics.

### F. Example 24—Antimicrobial Performance

Standard cotton fabric W-10A from WFK was treated with a 65 ppm of aqueous solution of Example 16 prepared by diluting the polymer of Example 16 in Singapore tap water which has maximum water hardness of 150 ppm.

The treatment of the test fabric was done using LaunderOmeter® (SDLATLAS). The volume of the 65 ppm aqueous solution of Example 16 is 500 ml. The fabric to treatment liquor ratio (wt/wt) is 1 to 10. The treatment was done at temperature of 40 degree centigrade for 30 minutes. Fifty pieces of steel balls was added to the LaunderOmeter® pot. After the treatment, the fabrics were rinse twice with Singapore tab water for 1 minute each. Finally, the fabrics were line-dried at temperature 22 degree centigrade with humidity of 60%.

The treated and dried fabrics were cut into square swatches with size of 3.8×3.8+0.1 cm. The number of swatches needed for the test is equal to 1.0+0.1 gram. Bacteria strain Klebsiella pneumonia (ATCC 4352) was used for the test. The detail test was done according to the protocol AATCC TM 100-2019 which is available online via https://members.aatcc.org/store/tm100/513/.

The test results were shown in the Table 16 below.

TABLE 16
Count of test microorganism recovered from the inoculated fabric.

| | Untreated | Fabric treated with |
|---|---|---|
| | cotton fabric | Polymer example 16 |
| Bacteria count at 0 hours, | 270000 | 230000 |
| CFU | | |
| Bacteria count at 24 hours, | 32000000 | 37000 |
| CFU | | |

The bacteria inoculated on the untreated cotton fabric grew from 270000 CFU to 32000000 CFU over 24 hours incubation whereas the bacteria inoculated on the cotton fabric treated with Polymer of example 16 reduced from 230000 CFU to 37000 CFU which showed that the Polymer of example 16 is capable of inhibiting the growth of the test bacteria.

1. A polymer comprising the following repeating unit I: 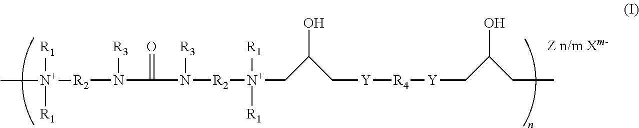
wherein:
R₁ are each independently a hydrogen atom, a C₁ to C₄ alkyl or hydroxyalkyl group, or a C₂ to C₄ alkenyl group;
R₂ are each independently a C₂ to C₁₀ alkylene group;
R₃ are each independently a hydrogen atom, a C₁ to C₄ alkyl or hydroxyalkyl group, or a C₂ to C₄ alkenyl group;
R₄ represents an oxyalkylene group of formula A:
(—CHR₅CH₂)ₐ-(OCH₂CHR₆)_{b}-(OCH₂CHR₇)_{c}-(OCH₂CHR₈)_{d} (A)
wherein
“a” represents 1;
“b” represents an integer of 1 or more;
“c” and “d” represent independently from one another an integer of 0 or more; and
R₅, R₆, R₇ and R₈ represent independently from one another a hydrogen atom or a C₁ to C₄ alkyl group;
Y represents an oxygen atom, —NR₉- or —N⁺R₁₀R₁₁- wherein
R₉ represents a hydrogen atom or a radical deriving from any electrophilic compound present in the reaction mixture during the synthesis process of the polymer and that reacted by alkylation reaction with a secondary amine (Y=—NH—) present on the polymer during its synthesis; and
R₁₀ and R₁₁ represent radicals deriving from any electrophilic compounds present in the reaction mixture during the synthesis process of the polymer and that are reacted by successive alkylation reactions with a secondary amine (Y=—NH—) and then a tertiary amine (e.g. Y=—NR₁₀-) present on the polymer during its synthesis;
Z represents a positive integer from 2 to 4;
n represents a positive integer from 1 to 50
m represents a positive integer from 1 to 3; and
X represents an electrophilic group.

2. The polymer according to claim 1, wherein in formula I:
R₁ are C₁ alkyl groups;
R₂ are C₂ or C₃ alkylene group;
R₃ are hydrogen atoms.

3. The polymer according to claim 1, wherein in formula I:
R₄ represents an oxyalkylene group of formula A:
(—CHR₅CH₂)ₐ-(OCH₂CHR₆)_{b}-(OCH₂CHR₇)_{c}-(OCH₂CHR₈)_{d} (A)
wherein
“a” represents 1;
“b” represents an integer of 1 or more;
“c” and “d” represent independently from one another an integer of 0 or more; and
R₅ is methyl or hydrogen, R₆ is hydrogen, R₇ is hydrogen or methyl and R₈ is methyl group; and
Y represents an oxygen atom.

4. The polymer according to claim 1, wherein in formula I:
n represents a positive integer from 1 to 50;
m is 1 and
X is Cl.

5. The polymer according to claim 1, having a weight average molecular weight ranging from 1 to 100 kg/mol.

6. The polymer according to claim 1, having a cationic charge density ranging from 0.1 to 4.25 mmol/g.

7. A [[P]] process for preparing a polymer according to claim 1, comprising a step (i) of reacting a compound of formula II: 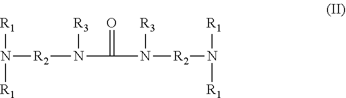
wherein
R₁ are each independently a hydrogen atom, a C₁ to C₄ alkyl or hydroxyalkyl group, or a C₂ to C₄ alkenyl group;
R₂ are each independently a C₂ to C₁₀ alkylene group;
R₃ are each independently a hydrogen atom, a C₁ to C₄ alkyl or hydroxyalkyl group, or a C₂ to C₄ alkenyl group;
with a compound of formula III: 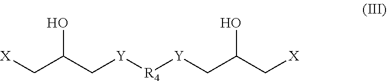
wherein
R₄ represents an oxyalkylene group of formula A:
(—CHR₅CH₂)ₐ-(OCH₂CHR₆)_{b}-(OCH₂CHR₇)_{c}-(OCH₂CHR₈)_{d} (A)
wherein
“a” represents 1;
“b” represents an integer of 1 or more;
“c” and “d” represent independently from one another an integer of 0 or more; and
R₅, R₆, R₇ and R₈ represent independently from one another a hydrogen atom or a C₁ to C₄ alkyl group;
Y represents an oxygen atom, —NR₉- or —N⁺R₁₀R₁₁- wherein
R₉ represents a hydrogen atom or a radical deriving from any electrophilic compound present in the reaction mixture during the synthesis process of the polymer and that reacted by alkylation reaction with a secondary amine (Y=—NH—) present on the polymer during its synthesis; and
R₁₀ and Ru represent radicals deriving from any electrophilic compounds present in the reaction mixture during the synthesis process of the polymer and that reacted by successive alkylation reactions with a secondary amine (Y=—NH—) and then a tertiary amine (e.g. Y=—NR₁₀-) present on the polymer during its synthesis; and
X represents an electrophilic group, preferably selected from halogens or sulfates.

8. The process according to claim 7, wherein the molar ratio between the compound of formula II and the compound of formula III is ranging from 0.75 to 1.25.

9. The process according to claim 7, wherein the compound of formula II is prepared by reaction of a diamine of formula IV: 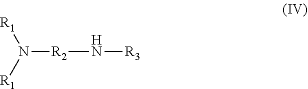
with urea of formula V NH₂CONH₂ (V), in a molar ratio IV:V of at least 1.5 mol of the compound IV to 1 mol of compound V.

10. The process according to claim 7, wherein the compound of formula III is prepared by reaction of a bifunctional compound of formula VI:
HY—R₄—YH (VI)
with on oxirane containing compound of formula VII:
X—CH₂—CH(CH₂O) (VII),
in presence of an acid catalyst and in a molar ratio VII:VI ranging from 1.8 to 2.1 of the molecule VII to 1 mol of molecule VI.

11. The process according to claim 7, wherein R₄ represents an oxyalkylene group of formula A:
(—CHR₅CH₂)ₐ-(OCH₂CHR₆)_{b}-(OCH₂CHR₇)_{c}-(OCH₂CHR₈)_{d} (A)
wherein
“a” represents 1;
“b” represents an integer of 1 or more and preferably up to 70;
“c” and “d” represent independently from one another an integer of 0 or more; and
R₅ is methyl or hydrogen, R₆ is hydrogen, R₇ is hydrogen or methyl and R₈ is methyl group; and
Y represents an oxygen atom.

12. A method comprising improving biodegradability for home and personal care applications with the polymer according to claim 1.

13. A method comprising improving biodegradability for industrial and institutional cleaning applications with the polymer according to claim 1.

14. A method comprising killing or inhibiting the growth of microorganisms with the polymer according to claim 1, in
i. laundry compositions;
ii. hard surface cleaning compositions;
iii. dish wash cleaning compositions; or
iv. hair care compositions.

15. A method comprising incorporating the polymer according to claim 1, as dye fixing agent or transfer inhibitor agent or soil anti-redeposition agent or soil release agent or laundry additives deposition agent in laundry compositions.

16. A method comprising incorporating the polymer according to claim 1, as soil anti-redeposition agent or soil release agent or shining agent in dish wash compositions.

17. A formulation comprising:
the polymer as defined in claim 1; and
an adjuvant selected from a surfactant and/or a thickening agent.
